(19) United States
(12) Patent Application Publication
(10) Pub. No.: US 2013/0341132 A1
(43) Pub. Date: Dec. 26, 2013

(54) FRICTION BRAKE

(71) Applicant: Dietmar Baumann, Hemmingen (DE)

(72) Inventor: Dietmar Baumann, Hemmingen (DE)

(73) Assignee: Robert Bosch GmbH, Stuttgart (DE)

(21) Appl. No.: 13/996,732

(22) PCT Filed: Dec. 13, 2011
(86) PCT No.: PCT/EP2011/072522

§ 371 Date: Sep. 9, 2013

(30) Foreign Application Priority Data
Dec. 23, 2010 (DE) 102010064042.5

(51) Int. Cl. F16D 55/02

(52) U.S. Cl. CPC F16D 55/02
USPC 188/72.1

(57) ABSTRACT

The disclosure relates to a friction brake in the design of a disc brake as a vehicle brake having a piezo element as an actuating device and a piezo element as a force-voltage converter on which a movable friction brake pad is supported against turning with a brake disc and thus generates a voltage on the piezo element which an electronic control unit couples into the piezo element of the actuating device, causing the friction brake to have a self-amplification.

The invention relates to a friction brake having a friction brake lining and an actuating device, which serves to press the friction brake lining against a brake body, having the features of the preamble of claim 1. The friction brake is, in particular, a vehicle brake, for example a disk brake or also a drum brake. In the case of a disk brake the brake body is a brake disk, in the case of drum brake it is a brake drum.

### STATE OF THE ART

Electromechanical friction brakes, which are frequently embodied as disk brakes, are known in the form of wheel brakes for motor vehicles. Such known friction brakes comprise an electromechanical actuating device having an electric motor and a spindle drive for converting a rotational movement of the electric motor into a translational movement for pressing a friction brake lining against a brake body, that is to say in the case of a disk brake against a brake disk.

Self-energizing forms of such disk brakes are also known. In these brakes the friction brake lining is moveable in a direction of rotation of the brake body, there being no compelling reason for the brake body to be capable of movement on a circular orbit around the axis of rotation of the brake disk. The brake body may also move in the direction of a chord to the brake disk, for example. The friction brake lining is braced against a wedge incline to the brake disk. If the friction brake lining is pressed against the brake disk when the brake is actuated by the actuating device, the rotating brake disk exerts a friction force on the friction brake lining, which impels this in the direction of a narrowing wedge gap between the wedge incline and the brake disk. Due to the wedge principle, the wedge incline exerts a bracing force on the friction brake lining, which has a component perpendicular to the brake disk. This component of the bracing force perpendicular to the brake disk increases an application force with which the friction brake lining is pressed against the brake disk, that is to say a brake force is increased. The wedge incline and an associated wedge on a rear side of the friction brake lining remote from the brake disk can be understood as a wedge mechanism and as a self-energizing device.

### DISCLOSURE OF THE INVENTION

In the friction brake according to the invention having the features of the preamble of claim 1, the friction brake lining is again moveable in the direction of rotation of a brake body. A force-voltage transducer braces the friction brake lining to prevent it moving together with the rotating brake body. The force-voltage transducer converts a support force, with which the friction brake lining is braced against it, into an electrical voltage, the term electrical voltage also being taken to mean an electrical current. The electrical voltage of the force-voltage transducer can be fed to the actuating device, in order to increase the application force, that is to say the force with which the friction brake lining is pressed against the brake body. Brake force boosting or self-energization is thereby possible. One additional advantage is that the force-voltage transducer can also be used as a brake force sensor: by measuring the electrical voltage of the force-voltage transducer it is possible to determine the support force with which the friction brake lining is braced against it, and hence the brake force of the friction brake. There is no need for an additional sensor for measuring the brake force. From the brake force and the application force exerted on the friction brake lining it is moreover possible to determine the coefficient of friction between the friction brake lining and the brake body. The friction brake lining is preferably braced in both directions of rotation of the brake body against one or various force-voltage transducers, in order to allow self-energization in both directions of rotation of the brake body.

Advantageous embodiments and developments of the invention specified in claim 1 form the subject matter of the dependent claims.

Claim 3 proposes that the actuating device comprise a voltage-force transducer, which converts an electrical voltage or an electrical current into a force, with which the friction brake lining is pressed against the brake body. The voltage-force transducer makes it easy to couple in the electrical voltage generated by the force-voltage transducer when the friction brake lining is braced against it, with the friction brake actuated and the brake body rotating. This embodiment of the invention facilitates self-energization. A further advantage is a high dynamic of the brake actuation.

Inductive transducers having a solenoid coil, for example, or capacitive transducers having a moving capacitor plate, for example, are feasible. The force-voltage transducer and/or the voltage-force transducer preferably comprise one (or more) piezo-electric elements. A piezo-electric element can be used both as a force-voltage transducer, because is generates an electrical voltage when subjected to a force, and as a voltage-force transducer, because it is deformed when an electrical voltage is applied, thereby generating a force. Piezo-electric elements are compact, robust and virtually free from wear; their electric power consumption is low.

Claim 5 proposes an electronic control unit, which is interconnected between the force-voltage transducer and the voltage-force transducer. The electronic control unit allows regulation of the electrical voltage, which is transmitted by the force-voltage transducer, against which the friction brake lining is braced, to the voltage-force transducer, which presses the friction brake lining against the brake body. In this way it is possible to regulate the self-energization of the friction brake according to the invention. Since the coefficient of friction between the friction brake lining and the brake body can be determined from the voltage generated by the force-voltage transducer, and the force with which the friction brake lining is pressed against the brake body, it is possible, by means of the electronic control unit, to regulate the self-energization of the friction brake according to the invention as a function of the coefficient of friction. At the same time the electronic control unit is capable of regulating the brake force of the friction brake and the application force, with which the friction brake lining is pressed against the brake body. The term “regulation” is here intended to include control.

### BRIEF DESCRIPTION OF THE DRAWING

The invention is explained in more detail below on the basis of exemplary embodiments represented in the drawing. The figures show three embodiments of friction brakes according to the invention. The figures are to be interpreted as schematic and simplified representations as an aid to understanding and explaining the invention.

### EMBODIMENTS OF THE INVENTION

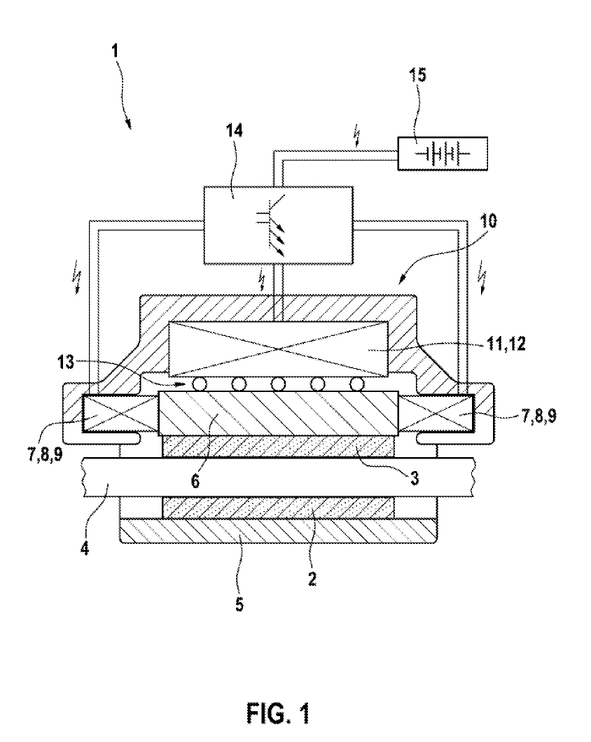

The friction brake 1 according to the invention represented in FIG. 1 is a wheel brake for a motor vehicle, that is to say a vehicle brake. It takes the form of a disk brake. The friction brake 1 comprises two friction brake linings 2, 3, which are arranged in a brake caliper 5 on both sides of a brake disk 4. In general terms the brake disk 4 may also be considered as a brake body to be braked. One of the two friction brake linings 2 is fixedly arranged in the brake caliper 5; the other friction brake lining 3 is moveable in a circumferential direction, that is to say moveable in the brake caliper 5 in both directions of rotation of the brake disk 4. On a rear side remote from the brake disk 4 the moveable friction brake lining 3 comprises a lining carrier 6, which at each of the two ends in the circumferential direction is braced against a piezo-electric element 7, which forms a force-voltage transducer 8 and at the same time a brake force sensor 9.

As actuating device 10, or at any rate as an integral part of an actuating device 10, the friction brake 1 comprises a further piezo-electric element 11, which is arranged in the brake caliper 5 on a rear side of the lining carrier 6 remote from the brake disk 4. To enable the lining carrier 6 with the friction brake lining 3 to move in the circumferential direction of the brake disk 4, it is moveable in its direction of movement relative to the piezo-electric element 11. The drawing shows a rolling bearing 13 for moveable bracing of the lining carrier 6 on the piezo-electric element 11; a slide bearing, a sliding guide etc. is also feasible. This piezo-electric element 11 forms a voltage-force transducer 12.

The piezo-electric elements 7, which brace the moveable friction brake lining 3 by way of its lining carrier 6 in the brake caliper 5 to prevent it rotating together with the brake disk 4, are electrically connected to an electronic control unit 14, to which the piezo-electric element 11, which forms the voltage-force transducer 12 and at the same time the actuating device 10, is also connected. The electronic control unit 14 is connected to a vehicle electrical system 15 of a motor vehicle, in which the friction brake 1 is used as wheel brake.

The electronic control unit 14 regulates an actuating force or application force or the braking force of the friction brake 1. For brake actuation, an electrical voltage is applied to the piezo-electric element 11, which forms the voltage-force transducer 12. The voltage applied causes the piezo-electric element 11 to increase in thickness and via the lining carrier 6 it presses the moveable friction brake lining 3 against the brake disk 4. Pressing the moveable friction brake lining 3 against the brake disk 4 displaces the brake caliper 5, which is embodied as a floating caliper, transversely to the brake disk 4 and presses the fixed friction brake lining 2 against the other side of the brake disk 4, which is thereby braked.

When the brake disk 4 rotates, it exerts a friction force on the two friction brake linings 2, 3 in their circumferential direction. The moveable friction brake lining 3 is braced by way of its lining carrier 6 against the piezo-electric elements 7, which form the force-voltage transducer 8, preventing it from rotating together with the brake disk 4, so that the piezo-electric element 7, which in the direction of rotation of the brake disk 4 is situated away from the lining carrier 6, is subjected to the friction force, which the rotating brake disk 4 exerts on the moveable friction brake lining 3 pressed against it when the friction brake 1 is actuated. By way of the lining carrier 6, the piezo-electric element 7 braces the friction brake lining 3 with a support force, which is equal to the friction force between the brake disk 4 and the friction brake lining 3 and which is opposed to the friction force. The friction force transmitted to the piezo-electric element 7 forming the force-voltage transducer 8 deforms the piezo-electric element 7 and generates an electrical voltage on the piezo-electric element 7, which is fed to the electronic control unit 14. The electronic control unit 14, which is interconnected between the piezo-electric elements 7, 11, couples in the electrical voltage of the piezo-electric element 7 bracing the friction brake lining 3 in the circumferential direction and transmits it to the piezo-electric element 11, which forms the actuating unit 10. The electrical voltage applied to the latter piezo-electric element 11 and hence the application force, with which it presses the friction brake lining 3 against the brake disk 4, is thereby increased. The friction brake 11 has a piezo-electric self-energization. The level of the self-energization can be regulated by the level of the electrical voltage, which the electronic control unit 14 couples in.

The voltage generated by bracing the friction brake lining 3, via its lining carrier 6, against the piezo-electric element 7 forming the force-voltage-transducer 8 is a measure of the brake force, which the friction brake 1 exerts on the brake disk 4. For this reason the piezo-electric elements 7, which form the force-voltage transducer 8, at the same time also form brake force sensors 9. From the brake force and the application force, with which the friction brake lining 3 is pressed against the brake disk 4, and which results from the electrical voltage which the electronic control unit 14 applies to the piezo-electric element of the actuating device 10, it is possible to calculate a coefficient of friction μ, which prevails between the moveable friction brake lining 3 and the brake disk 4. This affords an easy way of regulating the level of self-energization of the friction brake 1 as a function, among other things, of the coefficient of friction μ.

Apart from a high dynamic, the piezo-electric element 11, which forms the voltage-force transducer 12, has a low electrical power consumption, because it is deformed by the application of an electrical voltage with only a slight or virtually no current consumption. The electrical power consumption and hence the load on the vehicle electrical system 15 by the friction brake according to the invention is therefore low. A further advantage is that the piezo-electric elements 7, 11 are virtually wear-free and that the friction brake 1 has very few moving parts and is thereby virtually wear-free and unsusceptible to fouling. Apart from changing the friction brake linings 2, 3, the friction brake 1 is virtually maintenance-free.

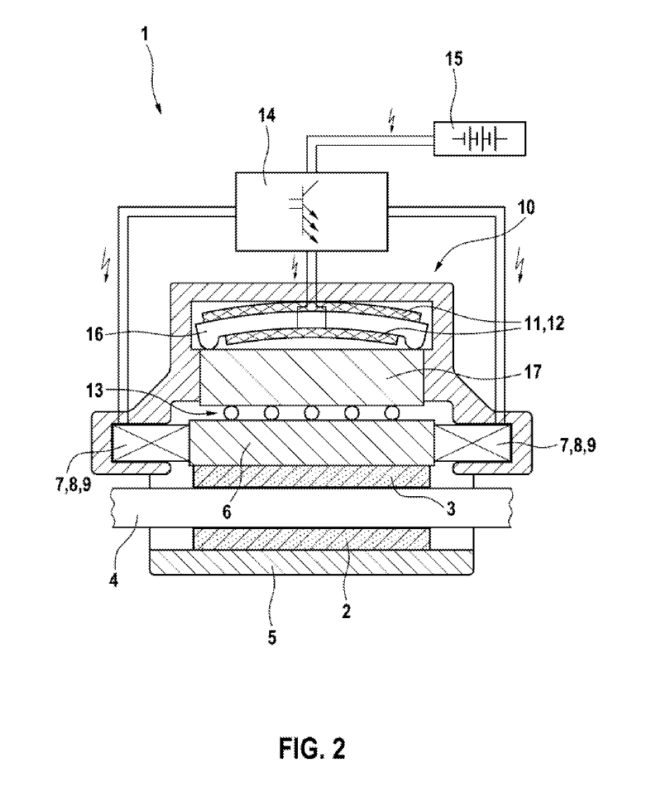

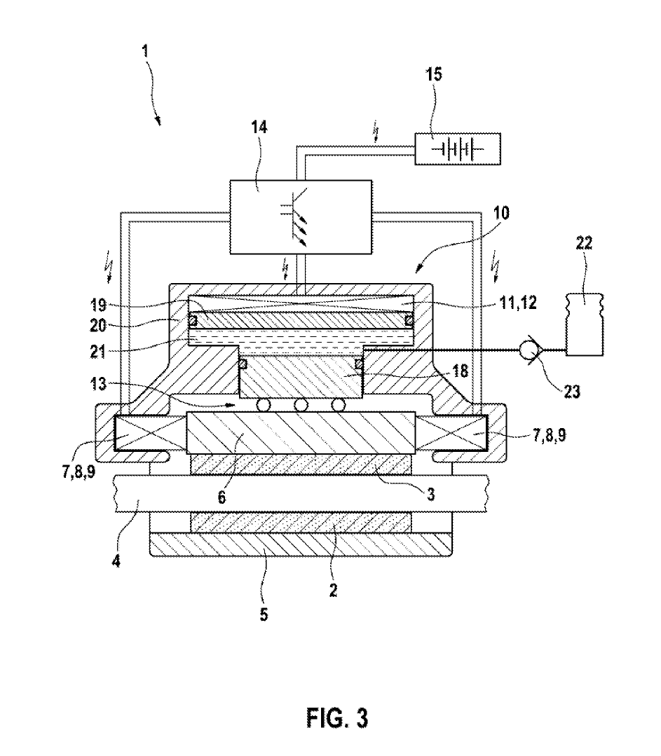

In the following explanation of FIGS. 2 and 3 corresponding components are denoted by the same reference numerals as in FIG. 1. The actuating device 10 of the friction brake 1 in FIG. 2 comprises a bar or plate-shaped bending element 16, on both sides of which piezo-electric elements 11 are arranged as voltage-force transducer 12. The piezo-electric elements 11 have a shear-resistant connection to the bending element 16; the application of an electrical voltage to both of the piezo-electric elements 11 by the electronic control unit 14 causes these elements to deform and to bend the bending element 16, increasing its curvature.

At its center the bending element 15 is braced by one of the two piezo-electric elements 11 against the brake caliper 5. The ends or edges of the bending element 16 bear on an intermediate piece 17, which is displaceably guided in the brake caliper 5 transversely to the brake disk 4 in the manner of a piston. By way of a rolling bearing 13, slide bearing, sliding guide etc the intermediate piece 17 bears on the rear side of the lining carrier 6 of the moveable friction brake lining 3. The bending element 16 can be bent and its curvature increased by the application of an electrical voltage to the two piezo-electric elements 11 of the bending element 16. By way of the intermediate piece 17, the bending element 16 thereby presses the moveable friction brake lining 1 against the brake disk 4, thereby actuating the friction brake 1. The bending element 16 with its two piezo-electric elements 11 are an integral part of the actuating device 10 of the friction brake 1 in FIG. 2. The bending element 16 increases an adjustment travel, which the piezo-electric elements 11 produce through their deformation when an electrical voltage is applied.

Otherwise the friction brake 1 in FIG. 2, in particular the self-energization by way of the piezo-electric elements 7, which form the force-voltage transducer 8 and which at the same time form the brake force sensors 9, and which brace the moveable friction brake lining 3 to prevent it rotating together with the brake disk 4, and in terms of the piezo-electric self-energization, is of identical design and functions in the same way as the friction brake 11 in FIG. 1, the explanations regarding which are therefore referred to here. One of the piezo-electric elements 11 is sufficient to bend the bending element 16, thereby actuating the friction brake 1. The second piezo-electric element 11 on the other side of the bending element 16 serves for temperature compensation. In addition a bending force and/or a deformation travel, that is to say the application force and/or the adjustment travel are increased by the second piezo-electric element 11.

The actuating device 10 of the friction brake 1 according to the invention in FIG. 3 comprises two pistons 18, 19, which in a manner comparable to the pistons of a hydraulic disk brake are accommodated in the brake caliper 5 so that they are displaceable transversely to the brake disk 4. For this purpose the brake caliper 5 is embodied as a cylinder 20; it contains a hydraulic fluid 21 between the two pistons 18, 19. The rear side of the lining carrier 6 of the moveable friction brake lining 3 bears on one of the two pistons 18, as on the piezo-electric element 11 in FIG. 1 and on the intermediate piece 17 in FIG. 2, by way of a rolling bearing 13, a slide bearing, a sliding guide etc. On its rear side remote from the brake disk 4 the other piston 19 comprises the piezo-electric element 11, which forms the voltage-force transducer 12. The piston 19 assigned to the piezo-electric element 11 has a larger diameter than the piston 18 assigned to the friction brake lining 3, so that travel is transmitted from the piezo-electric element 11 to the friction brake lining 3. The cylinder of the brake caliper 5 has a stepped diameter corresponding to the diameter of the pistons 18, 19. The cylinder/piston arrangement 18, 19, 20 forms a hydraulic travel transmitter, which amplifies a variation in the thickness of the piezo-electric element 11, when an electrical voltage is applied, and thereby increases an adjustment travel or actuation travel. The piezo-electric element 11, the two pistons 18, 19 and the cylinder 20 form the actuating device 10 of the friction brake 1 in FIG. 3, or at any rate they are an integral part of the actuating device 10.

In order to compensate for lining wear of the friction brake linings 2, 3, a reservoir 22 with hydraulic fluid is connected to the cylinder 20 by way of a non-return valve 23, through which a flow can pass in the direction of the cylinder 20. The connection of the reservoir 23 to the cylinder 20 is also feasible using a so-called snifting bore, which when the piston 19 moves is closed, as is familiar from brake master cylinders of vehicle hydraulic brake systems, by a central valve, which hydraulically separates the reservoir 23 from the cylinder 20 when one of the pistons 18, 19 moves, as is likewise known from brake master cylinders, or by a solenoid valve, which is controlled by the electronic control unit 20 (not shown).

Otherwise the friction brake 1 in FIG. 3 is of identical design and functions in the same way as the friction brake 1 in FIG. 1, so that in order to avoid repetitions in explaining FIG. 3, reference is additionally made to the explanations of FIG. 1.

The piezo-electric actuating devices 10 may also be realized independently of the piezo-electric elements 7, which form the force-voltage transducer 8, on friction brakes without self-energization or having other forms of self-energization.

1. A friction brake, comprising:
a brake body;
a friction brake lining; and
an actuating device configured to press the friction brake lining against the brake body to actuate the friction brake,
wherein the friction brake lining is moveable in a direction of rotation of the brake body, and
wherein the friction brake lining includes a force-voltage transducer, against which the friction brake lining is braced to prevent the friction brake lining from rotating together with the brake body.

2. The friction brake as claimed in claim 1, wherein the force-voltage transducer is a piezo-electric element.

3. The friction brake as claimed in claim 1, wherein:
the actuating device includes a voltage-force transducer configured to convert an electrical voltage of the force-voltage transducer into an application force, and
the voltage-force transducer is configured to press the friction brake lining against the brake body.

4. The friction brake as claimed in claim 3, wherein the voltage-force transducer is a piezo-electric element.

5. The friction brake as claimed in claim 3, further comprising an electronic control unit interconnected between the force-voltage transducer and the voltage-force transducer.

6. The friction brake as claimed in claim 1, wherein the force-voltage transducer forms a brake force sensor.

7. The friction brake as claimed in claim 3, wherein:
the actuating device includes a bending element configured to bend to press the friction brake lining against the brake body, and
the voltage-force transducer is configured to bend the bending element when an electrical voltage is applied.

8. The friction brake as claimed in claim 7, wherein the bending element has a voltage-force transducer on two opposing sides.

9. The friction brake as claimed in claim 3, wherein the actuating device includes a travel transmitter configured to transmit a movement of the voltage-force transducer.

10. The friction brake as claimed in claim 9, wherein the actuating device includes a hydraulic travel transmitter.
